(19) United States
(12) Patent Application Publication
(10) Pub. No.: US 2025/0077616 A1
(43) Pub. Date: Mar. 6, 2025

(54) OPTIMIZATION DEVICE, OPTIMIZATION METHOD, AND OPTIMIZATION PROGRAM

(71) Applicant: NEC Corporation, Minato-ku, Tokyo (JP)

(72) Inventors: Akira KITAOKA, Tokyo (JP); Riki Eto, Tokyo (JP)

(73) Assignee: NEC Corporation, Minato-ku, Tokyo (JP)

(21) Appl. No.: 18/285,749

(22) PCT Filed: Apr. 11, 2023
(86) PCT No.: PCT/JP2023/014670

§ 371 Date: Oct. 5, 2023

(51) Int. Cl. G06F 17/16

(52) U.S. Cl. CPC G06F 17/16

(57) ABSTRACT

An AI (Artificial Intelligence) system comprising: the input means 81 accepts input of multiple candidate solutions to an optimization problem in which an objective function is express as an inner product of a feature and weight, or expressed in a bilinear form, and weight of the objective function; the optimal solution determination means 82 determines as an optimal solution, among the candidate solutions, the candidate solution that maximizes the inner product with the weight of the objective function or the candidate solution that maximizes a value of the bilinear form; and the output means 83 outputs the optimal solution.

### TECHNICAL FIELD

This invention relates to an optimization device, an optimization method, and an optimization program for deriving a pseudo-optimal solution to an optimization problem.

### BACKGROUND ART

Various algorithms for solving combinatorial optimization problems are known. Non-Patent Literature 1 describes the interior point method, a type of algorithm. The interior point method is a method to approach the optimal solution from a sequence of interior points that satisfy constraints.

Other known solvers for solving optimization problems include the simplex method, cutting plane method, branch-and-bound method, and branch-and-cut method. The simplex method is a method to approach the optimal solution by moving the vertices of a polyhedron when the constraint condition is the polyhedron. Although it depends on the problem, the interior point method tends to be more efficient than the simplex method for large-scale calculations. The cutting plane method, the branch-and-bound method, and the branch-and-cut method are mainly used for solving integer linear programming problems.

### CITATION LIST

### Non Patent Literature

NPL 1: Shinji Mizuno, “Introduction to the Interior Point Method,” [online], Nov. 9, 2010, [retrieved Dec. 27, 2022], Internet <URL: http://www.me.titech.ac.jp/-mizu_lab/text/PDF-IP/IP1-IP.pdf>

### SUMMARY OF INVENTION

### Technical Problem

It is also known that the above-mentioned interior point method, simplex method, cutting plane method, branch-and-bound method, and branch-and-cut method require an enormous amount of computation when solving optimization problems. For example, even with the interior point method, which is said to be the fastest, it is known that the computation speed is proportional to the cube of the dimension of the feature space assumed in the constraint conditions.

On the other hand, there are cases where a rough optimization result (sometimes referred to as a pseudo-optimal solution) is needed without requiring an exact optimal solution, but with an emphasis on speed. However, the algorithms described above are not suitable for this purpose. Therefore, it is desirable to obtain a pseudo-optimal solution faster than, for example, the interior point method, with an emphasis on speed.

Therefore, it is an exemplary object of the present invention to provide an optimization device, an optimization method, and an optimization program that can derive a pseudo-optimal solution in a combinatorial optimization problem.

### Solution to Problem

The optimization device according to the present invention includes: an input means which accepts input of multiple candidate solutions to an optimization problem in which an objective function is express as an inner product of a feature and weight, or expressed in a bilinear form, and input of weight of the objective function; an optimal solution determination means which determines as an optimal solution, among the candidate solutions, the candidate solution that maximizes the inner product with the weight of the objective function or the candidate solution that maximizes a value of the bilinear form; and an output means which outputs the optimal solution.

The optimization method according to the present invention includes: accepting input of multiple candidate solutions to an optimization problem in which an objective function is express as an inner product of a feature and weight, or expressed in a bilinear form, and input of weight of the objective function; determining as an optimal solution, among the candidate solutions, the candidate solution that maximizes the inner product with the weight of the objective function or the candidate solution that maximizes a value of the bilinear form; and outputting the optimal solution.

The optimization program according to the present invention for causing the computer to execute: input process of accepting input of multiple candidate solutions to an optimization problem in which an objective function is express as an inner product of a feature and weight, or expressed in a bilinear form, and input of weight of the objective function; optimal solution determination process of determining as an optimal solution, among the candidate solutions, the candidate solution that maximizes the inner product with the weight of the objective function or the candidate solution that maximizes a value of the bilinear form; and output process of outputting the optimal solution.

### Advantageous Effects of Invention

According to the present invention, a pseudo-optimal solution in a combinatorial optimization problem can be derived.

### BRIEF DESCRIPTION OF DRAWINGS

FIG. 1 It depicts a block diagram showing an example configuration of an optimization device according to the present invention.

FIG. 2 It depicts a flowchart showing an example of the operation of the optimization device.

FIG. 3 It depicts a block diagram showing an overview of the optimization device according to the present invention.

FIG. 4 It depicts a schematic block diagram showing a configuration of a computer for at least one exemplary embodiment.

### DESCRIPTION OF EMBODIMENTS

The following is a description of the exemplary embodiment of the invention with reference to the drawings. This exemplary embodiment assumes that an objective function in the optimization problem is expressed as an inner product of features and weights, or expressed in bilinear form.

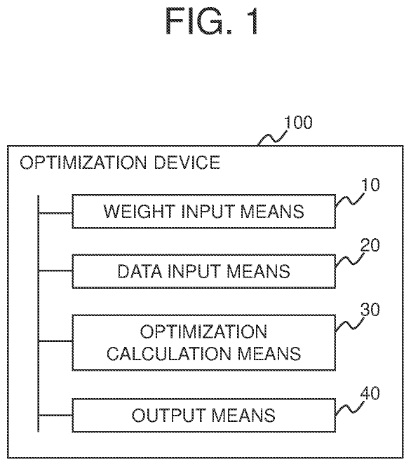

FIG. 1 is a block diagram showing an example configuration of an optimization device according to the present invention. The optimization device 100 of this exemplary embodiment includes a weight input means 10, a data input means 20, an optimization calculation means 30, and an output means 40.

The weight input means 10 accepts input for an optimization problem. Specifically, the weight input means 10 accepts input of an objective function to be targeted by the optimization problem. When the form of the objective function is fixed, the weight input means 10 may accept input of the weights of the objective function. As described above, this exemplary embodiment assumes that the objective function is expressed as an inner product of features and weights, or expressed in bilinear form, so the weight input means 10 may accept input of the objective function itself expressed in bilinear form, or the weights of the inner product.

For example, if the features are h(x) and the weights are φ∈H, the combinatorial optimization problem where the objective function is expressed by the inner product of the features and weights is represented by Equation 1, which is illustrated below. Note that H is an inner product space or a vector space in which duality can be defined. The weights φ used in this exemplary embodiment may be manually determined or derived by machine learning or other means.

max_{x∈X(s(n))}φ^{T}h(x) (Equation 1)

Let H\hat{ } be the dual space of the inner product space H, and let ψ₁^{T} ψ₂ denote the inner product or bilinear form for ψ₁ ∈H\hat{ } and ψ₂ ∈H. The inner product space H is isomorphic to the dual space H\hat{ } and can be identified. Examples of inner product spaces are the Euclid space R^{d} and the space 1².

The space 1² is a progression {aₘ}ₘ that may be finite or infinite and is the whole element such that Σₘ |aₘ|²<∞. An example that is not the inner product space is the space 1^{p}, where p is a number greater than or equal to 1 that is not 2. The space 1^{p} is a progression {aₘ}ₘ which may be finite or infinite, and is the whole element such that Σₘ |aₘ|^{p}<∞. The dual of the space 1^{p}is the space 1^{q} (it is supposed that 1/p+1/q=1), so ψ₁={aₘ}ₘ∈1^{p} and ψ₂={bₘ}ₘ∈1^{q} as the bilinear form ψ₁^{T}ψ₂:=Σₘ aₘ bₘ is well-defined.

The contents of s⁽ⁿ⁾ in Equation 1 above will be described later.

The data input means 20 accepts input of candidate solutions to the above optimization problem. In the following description, the number of candidate solutions is denoted by n and the candidate solutions are denoted by A(s⁽ⁿ⁾). Also, in the following description, n=1, . . . , N will be denoted by labels. In other words, the data input means 20 accepts input of solution candidates A(s⁽ⁿ⁾) for each label n.

s⁽ⁿ⁾ is a parameter expressing a state, space defined for natural numbers n=1, . . . , N (i.e., the label), corresponding to s⁽ⁿ⁾ in Equation 1 above. Let the space H′ be a vector space in which duality can be defined, A(s⁽ⁿ⁾) denotes data a (φ′, s⁽ⁿ⁾) generated from the compact set X (s⁽ⁿ⁾)⊂H′, φ′∈H\hat{ }, h(x) to achieve max_{x∈X(s}⁽ⁿ⁾) φ′^{T}(x) in the continuous vector value function h: H′ →H.

An example of a candidate solution A(s⁽ⁿ⁾) is {a(φ′, s⁽ⁿ⁾}_{φ′∈B} generated by randomly obtaining a finite subset B of H. The finite subset B of H may be predetermined, and the solution candidates may be generated by adding more specified elements after obtaining the elements at random.

Another example of a compact set X⊂H is the bounded closed set of an Euclidean space R^{d}. In particular, the set of finite disjoint union of closed convex polytope is a compact set.

The candidate solution accepted by the data input means 20 may be a solution generated using an optimization solver for solving max_{xΣX(s}⁽ⁿ⁾) φ^{T} h(x). For example, a continuous vector-valued function h:H′→H may be used so that φ^{T} h is a quasiconvex function for any φ∈H. Otherwise, each component of the vector-valued function h may be piecewise linear.

Here, the quasiconvex function is explained. That the function f: H→R is a quasiconvex function means that for any x₁, x₂ ∈H, t ∈[0, 1],

f(tx₁+(1−t)x₂)≤max{f(x₁),f(x₂)}.

An example of the quasiconvex function is a convex function.

The piecewise linear mapping is also explained. That the function f: H→R is piecewise linear means that for a finite partition Si of H, restricting f to Si makes it an affine function or linear function. An example of a piecewise linear function is a function that is |x| or max {a₁^{T} x+b₁, . . . , aₖ^{T} x+bₖ}.

More specifically, if h(x)=x and X is the set of finite disjoint union of closed convex polytope, then this optimization solver is a solver for solving mixed linear programming. The data input means 20 may accept the solution generated using this solver as candidate solution data.

Otherwise, if φ^{T} h(x)=x^{T} Ax+b^{T} x and X is the set of finite disjoint union of closed convex polytope, then this optimization solver is a solver for solving mixed quadratic programming. The data input means 20 may accept the solution generated using this solver as candidate solution data.

The optimization calculation means 30 calculates the candidate solution that maximizes the inner product with the weights or the candidate solution that maximizes the value of the bilinear form as a pseudo-optimal solution. Specifically, for each label n, the optimization calculation means 30 calculates the solution that maximizes the value of the bilinear form for the weights φ and the element of the candidate solution data A(s⁽ⁿ⁾). That is, given the weights φ and the data A(s⁽ⁿ⁾) of the candidate solutions, the optimization calculation means 30 calculates a (φ, s⁽ⁿ⁾)∈A (s⁽ⁿ⁾) that results in max_{a∈A(s(n))}φ^{T} a.

Here, why the above process yields the pseudo-optimal solution is explained. The vector-valued function h satisfies that (φ^{T}h(x) is a quasiconvex function. Therefore, the x that achieves max_{x∈X(s(n))} φ^{T}h(x) appears on the boundary of X(s⁽ⁿ⁾). In other words, h(x) that achieves max_{x∈X(s(n))}φ^{T}h(x) appears on the boundary of h(X(s⁽ⁿ⁾)).

The optimization set A(s⁽ⁿ⁾)={a(φ′,s⁽ⁿ⁾)}_{φ′∈B} is a subset of the boundary of h(X(s⁽ⁿ⁾)), so it is a collection of candidate optimization results. On a finite subset B of H, the optimization max_{x∈X(s(n))}φ^{T}h(x) and the result of the pseudo-optimization max_{a∈A(s(n))}φ^{T} a match, so the optimization calculation means 30 can calculate the pseudo-optimal solution.

It is also explained why the pseudo-optimal solution can be obtained even if each element of the vector-valued function h is piecewise linear. Since X (s⁽ⁿ⁾) is represented by a union of polytope, h(X(s⁽ⁿ⁾)) is a union of polytope by the nature of the vector-valued function h. Therefore, h(X) that achieves max_{x∈X(s(n))}φ^{T}h(x) appears on the boundary of h(X (s⁽ⁿ⁾)). The rest of the discussion is the same as in the case of quasiconvex functions, and the optimization calculation means 30 can calculate a pseudo-optimal solution.

Next, it is explained why the pseudo-optimal solution can be obtained faster than the interior point method. As described above, in the case of the interior point method, the computation speed is proportional to the cube of the dimension of the feature space assumed in the constraint condition. On the other hand, when the dimension of the vector space H is d, for each label n, the computational complexity is O(d|A(s⁽ⁿ⁾)|). Therefore, the pseudo-optimal solution can be obtained faster than the interior point method or the simplex method.

The output means 40 outputs the solution obtained by the optimization calculation means 30. In other words, the output means 40 outputs a (φ, s⁽ⁿ⁾) for each label n=1, . . . , N.

The weight input means 10, the data input means 20, the optimization calculation means 30, and the output means 40 are realized by a processor (for example, CPU (Central Processing Unit), GPU (Graphics Processing Unit)) of a computer that operates according to a program (a optimization program).

For example, a program may be stored in the storage unit (not shown) provided by the optimization device 100, and the processor may read the program and operate as the weight input means 10, the data input means 20, the optimization calculation means 30, and the output means 40 according to the program. In addition, the functions of the optimization device 100 may be provided in the form of SaaS (Software as a Service).

The weight input means 10, the data input means 20, the optimization calculation means 30, and the output means 40 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the optimization device 100 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

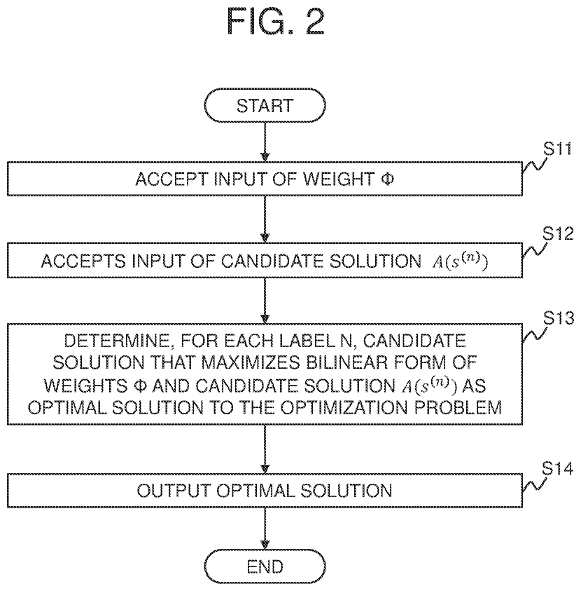

Next, the operation of the optimization device 100 will be described. FIG. 2 is a flowchart showing an example of the operation of the optimization device 100. The weight input means 10 accepts input of a weight p of an objective function (step S11). The data input means 20 accepts input of a candidate solution A (s⁽ⁿ⁾) of an optimization problem (step S12). The optimization calculation means 30 determines, for each label n, the candidate solution that maximizes the bilinear form of the weights φ and the candidate solution A (s⁽ⁿ⁾) as an optimal solution to the optimization problem (step S13). The output means 40 outputs the determined optimal solution (step S14).

As described above, in this exemplary embodiment, the weight input means 10 accepts input of weights of the objective function, and the data input means 20 accepts input of multiple candidate solutions to an optimization problem in which the objective function is express as an inner product of the feature and weight, or expressed in a bilinear form. The optimization calculation means 30 determines the candidate solution that maximizes the inner product of the weights of the objective function or the value of the bilinear form among the candidate solutions as the optimal solution to the optimization problem, and the output means 40 outputs the optimal solution. With such a configuration, a pseudo-optimal solution in the combinatorial optimization problem can be derived.

Specifically, the optimization calculation means 30 can obtain a pseudo-optimize result in the combinatorial optimization problem max_{x∈X(s(n))}φ′^{T}h (x). The computational complexity of the pseudo-optimization for each label n is O(d|A(s⁽ⁿ⁾)|). Therefore, the pseudo-optimal solution can be calculated faster than the interior point method or the simplex method.

Next, it is explained a specific example of the application of the optimization system in this exemplary embodiment to the shift scheduling problem. The shift scheduling problem is a type of integer linear programming. Constraints due to work procedures, constraints due to the number of people, constraints due to the time of day, etc. in the shift scheduling problem correspond to the element of the compact set X(s⁽ⁿ⁾). The solution candidate A(s⁽ⁿ⁾) also represents the set of optimal solutions a (φ′, s⁽ⁿ⁾) of the shift scheduling problem with weight φ′.

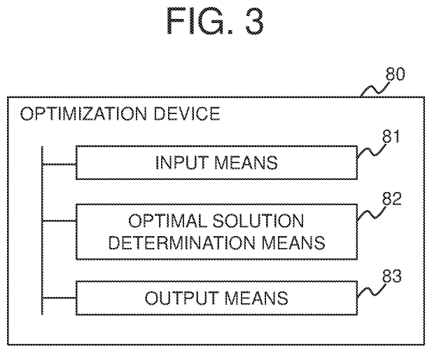

The following is an overview of the invention. FIG. 3 is a block diagram showing an overview of the optimization device according to the present invention. The optimization device 80 (e.g., optimization device 100) according to the present invention includes an input means 81 (e.g., the weight input means 10 and data input means 20) which accepts input of multiple candidate solutions (e.g., A(s⁽ⁿ⁾)) to an optimization problem (e.g., Equation 1 above) in which an objective function is express as an inner product of a feature and weight, or expressed in a bilinear form, and input of weight (e.g., weight φ) of the objective function, an optimal solution determination means 82 (e.g., the optimization calculation means 30) which determines as an optimal solution, among the candidate solutions, the candidate solution that maximizes the inner product with the weight of the objective function or the candidate solution that maximizes a value of the bilinear form, and an output means 83 (e.g., the output means 40) which outputs the optimal solution.

Such a configuration can derive a pseudo-optimal solution in a combinatorial optimization problem.

The input means 81 may accept as the candidate solution a solution generated by an optimization solver that solves an optimization problem in which the objective function is expressed as an inner product of a feature and weight, or expressed in a bilinear form, or a solution generated by a solver where each value of a vector-valued function is piecewise linear.

Specifically, the input means 81 may accept as data of the candidate solution a solution generated using a solver whose bilinear form with weight and a vector-valued function is a quasiconvex function.

Otherwise, the input means 81 may accept as data of the candidate solution a solution generated using a solver that solves a mixed integer programming problem (e.g., mixed linear programming, mixed quadratic programming).

The input means 81 may accept data generated by randomly obtaining a finite subset in an inner product space, or in a vector space in which duality can be defined as the candidate solution.

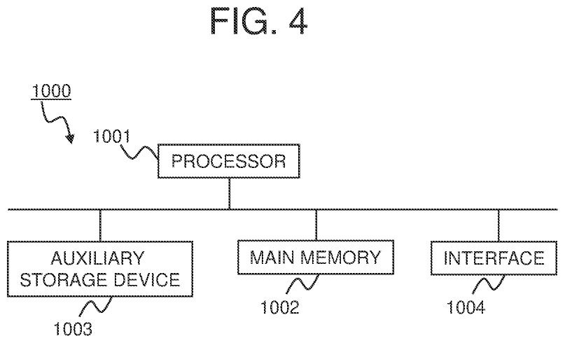

FIG. 4 is a schematic block diagram showing a configuration of a computer in at least one exemplary embodiment. A computer 1000 includes a processor 1001, a main storage device 1002, an auxiliary storage device 1003, and an interface 1004.

The optimization device 100 described above is implemented in the computer 1000. The operations of each of the above-mentioned processing parts are stored in the auxiliary storage device 1003 in the form of a program (optimization program). The processor 1001 reads the program from the auxiliary storage device 1003, loads the program in the main storage device 1002, and executes the above processing according to the program.

It is noted that, in at least one exemplary embodiment, the auxiliary storage device 1003 is an example of a non-transitory tangible medium. Other examples of the non-transitory tangible medium include a magnetic disk, a magneto-optical disk, CD-ROM (Compact Disc Read-only memory), DVD-ROM (Read-only memory), a semiconductor memory, etc., connected via the interface 1004. Furthermore, when the program is distributed to the computer 1000 via a communication line, the computer 1000 receiving the distribution may load the program in the main storage device 1002 and execute the above process.

Furthermore, the program may also be provided to implement a of the aforementioned functions. Furthermore, the program may be a so-called difference file (difference program), which implements the aforementioned functions in combination with other programs already stored in the auxiliary storage device 1003.

(Example of application) The following is an example of application of the optimization device of this exemplary embodiment to the medical and healthcare fields. Specifically, it is described an adaptation example of using an AI (Artificial Intelligence) system implementing the optimization device 100 of this exemplary embodiment to determine work shift schedules for nurses, physical therapists, caregivers, physicians, and other medical personnel at a medical facility.

The AI system is equipped with the optimization device 100 and at least one or more terminal devices. Nurses and physicians use the terminal devices to log in to the AI system and input data regarding constraint conditions, such as desired workdays. The terminal device transmits the input data regarding the constraint conditions to the optimization device 100.

The data scientist may also use a terminal device separate from the healthcare professional to input information about the objective function needed to determine work shift schedule. For example, the objective function may be set up so that each element of the objective function is piecewise linear when expressing a term that reflects more vacation requests, less overtime, fewer types of work on the same day, or as few people as possible who need to work.

The constraint conditions used by the optimization device 100 are not limited to information input by the nurse or physician from the terminal device. The optimization device 100 may use data stored in an external database to obtain constraint conditions. For example, the optimization device 100 may obtain the number of workers determined for each day from an external database as a constraint condition. The constraint conditions used by the optimization device 100 are not limited to the desired workdays, but may be any information regarding the work shifts of healthcare professionals. For example, the constraint condition may be the compatibility or relationships between nurses or physicians. If the constraint condition is compatibility between nurses or physicians, the optimization device 100 can perform work shift schedule so that nurses or physicians who are compatible with each other have the same work days and times.

The optimization device 100 determines the optimal work shift schedule based on the constraints and the objective function obtained from the terminal device and notifies the nurses and physicians through the terminal device. A description of how the optimization device 100 determines the shift schedule is omitted.

The nurse or physician reviews the work shift schedule and, if there are no problems, approves the work shift schedule through the terminal device. If there is a problem with the work shift schedule presented by the AI system, the nurse or physician logs into the AI system using the terminal device and requests a correction on the screen. In that case, the optimization device 100 may generate the work schedule again based on the requested corrections.

The above is a description of an example of the application of this exemplary embodiment to the medical and healthcare fields.

### REFERENCE SIGNS LIST

10 Weight input means
20 Data input means
30 Optimization calculation means
40 Output means
100 Optimization device
1000 Computer
1001 Processor
1002 Main storage device
1003 Auxiliary storage device
1004 Interface

What is claimed is:

1. An optimization device comprising:
a memory storing instructions; and
one or more processors configured to execute the instructions to:
accept input of multiple candidate solutions to an optimization problem in which an objective function is express as an inner product of a feature and weight, or expressed in a bilinear form, and input of weight of the objective function;
determine as an optimal solution, among the candidate solutions, the candidate solution that maximizes the inner product with the weight of the objective function or the candidate solution that maximizes a value of the bilinear form; and
output the optimal solution.

2. The optimization device according to claim 1, wherein the processor is configured to execute the instructions to accept as the candidate solution a solution generated by an optimization solver that solves an optimization problem in which the objective function is expressed as an inner product of a feature and weight, or expressed in a bilinear form.

3. The optimization device according to claim 1, wherein the processor is configured to execute the instructions to accept as data of the candidate solution a solution generated using a solver whose bilinear form with weight and a vector-valued function is a quasiconvex function.

4. The optimization device according to claim 1, wherein the processor is configured to execute the instructions to accept as data of the candidate solution a solution generated using a solver in which each component of a vector-valued function is a piecewise linear mapping.

5. The optimization device according to claim 1, wherein the processor is configured to execute the instructions to accept as data of the candidate solution a solution generated using a solver that solves a mixed integer programming problem.

6. The optimization device according to claim 1, wherein the processor is configured to execute the instructions to accept data generated by randomly obtaining a finite subset in an inner product space, or in a vector space in which duality can be defined as the candidate solution.

7. An optimization method comprising:
accepting input of multiple candidate solutions to an optimization problem in which an objective function is express as an inner product of a feature and weight, or expressed in a bilinear form, and input of weight of the objective function;
determining as an optimal solution, among the candidate solutions, the candidate solution that maximizes the inner product with the weight of the objective function or the candidate solution that maximizes a value of the bilinear form; and
outputting the optimal solution.

8. The optimization method according to claim 7, wherein
a solution generated by an optimization solver that solves an optimization problem in which the objective function is expressed as an inner product of a feature and weight, or expressed in a bilinear form is accepted as the candidate solution.

9. A non-transitory computer readable information recording medium storing an optimization program for causing a computer to execute:
accepting input of multiple candidate solutions to an optimization problem in which an objective function is express as an inner product of a feature and weight, or expressed in a bilinear form, and input of weight of the objective function;
determining as an optimal solution, among the candidate solutions, the candidate solution that maximizes the inner product with the weight of the objective function or the candidate solution that maximizes a value of the bilinear form; and
outputting the optimal solution.

10. A non-transitory computer readable information recording medium according to claim 9, wherein
a solution generated by an optimization solver that solves an optimization problem in which the objective function is expressed as an inner product of a feature and weight, or expressed in a bilinear form is accepted as the candidate solution.
